(19) United States
(12) Patent Application Publication
(10) Pub. No.: US 2011/0278320 A1
(43) Pub. Date: Nov. 17, 2011

(54) Method for handling valuable items

(76) Inventor: Kjell Lindskog, Skelleftea (SE)

(21) Appl. No.: 12/930,435

(22) Filed: Jan. 6, 2011

Related U.S. Application Data
(63) Continuation of application No. 11/992,561, filed on Mar. 25, 2008, now abandoned.

(30) Foreign Application Priority Data
Sep. 28, 2005 (SE) 0502117-5

(51) Int. Cl. G07F 11/00

(52) U.S. Cl. 221/1; 221/2

(57) ABSTRACT

The present invention relates to a method of handling valuable items, such as banknotes and the like, in which there is used a valuable item storage unit (10) which is adapted for receiving and dispensing valuable items/banknotes, wherein the unit (10) preferably includes an alarm device (12) and a destructive device/staining device/marking device (13). The unit (10) is moved between at least two different user stations in which its ability to receive and/or dispense valuable items/banknotes is utilized. When necessary, several such units (10) may be disposed as a common unit pack (1000) which is used in a pendular fashion in accordance with the concept of the invention. Two user stations that can be combined by way of example are shop cash-points (3000) and automatic telling machines (4000) wherein the banknotes are protected continuously and the need for security transportation can be reduced.

The present invention relates to a method for handling valuable items, such as banknotes and the like according to the preamble of claim 1. The invention also relates to the use of such a method.

Because banknotes and corresponding items are theft attractive property, there is a need to prevent the theft of such property. One way is to achieve this by storing the banknotes in a protective casing which is provided with an alarm and which includes a destructive means which renders the banknotes unusable, for instance by staining the banknotes when the protective casing is influenced in a way that initiates triggering of the alarm.

It is therefore desired to store the banknotes/valuable items to the greatest possible extent in a shell/casing that is protected by means of an alarm system and which preferably includes a destructive device/staining device so as to minimize the presence of what can be called naked or unprotected cash/banknotes. The risk of theft is reduced highly significantly by minimizing the presence of naked money.

One object of the present invention is to provide a method of minimizing the occurrence of so-called naked money (unprotected banknotes). This object is achieved by means of a method having the characteristic features set forth in the accompanying claims.

The following benefits are among the many benefits afforded by means of the invention.

The present invention provides continuous protection of stored banknotes in combination with significant logistic benefits. Such protection results in a minimized theft risk and a reduced necessity of valuable item transportation and with a reduced requirement of enumerating/counting the valuable items and storing said items in valuable item depots. The danger of theft or robbery is also reduced due to the fact off-loading, reloading or trans-shipment or the like of said items normally need not take place. The valuable items/banknotes are always protected.

Exemplifying embodiments of the present invention will now be described in more detail with reference to the accompanying drawings, in which

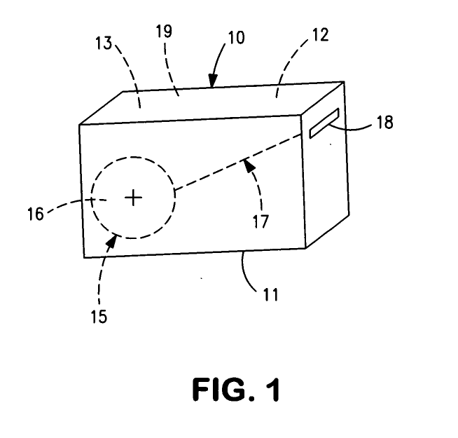

FIG. 1 illustrates a valuable item storage unit schematically and in perspective;

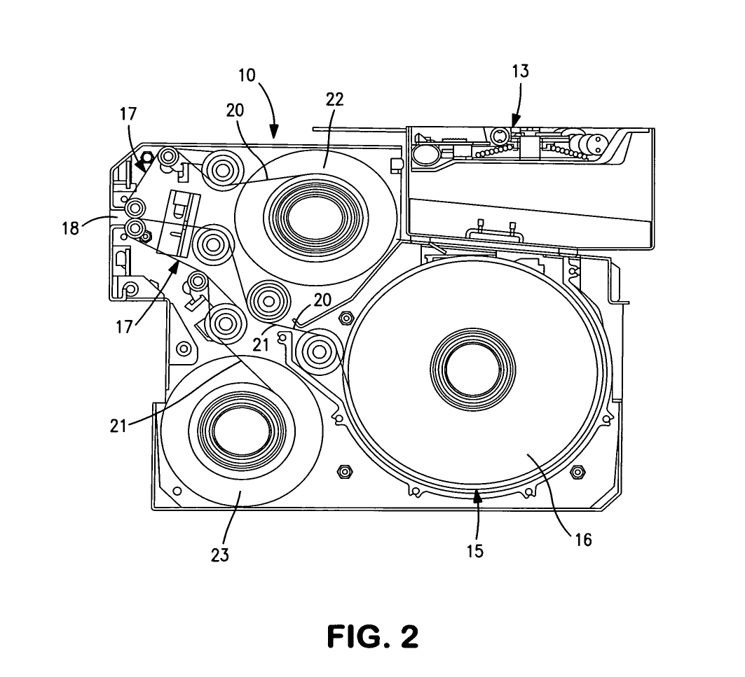

FIG. 2 is a broken side view of one embodiment of a valuable item storage unit;

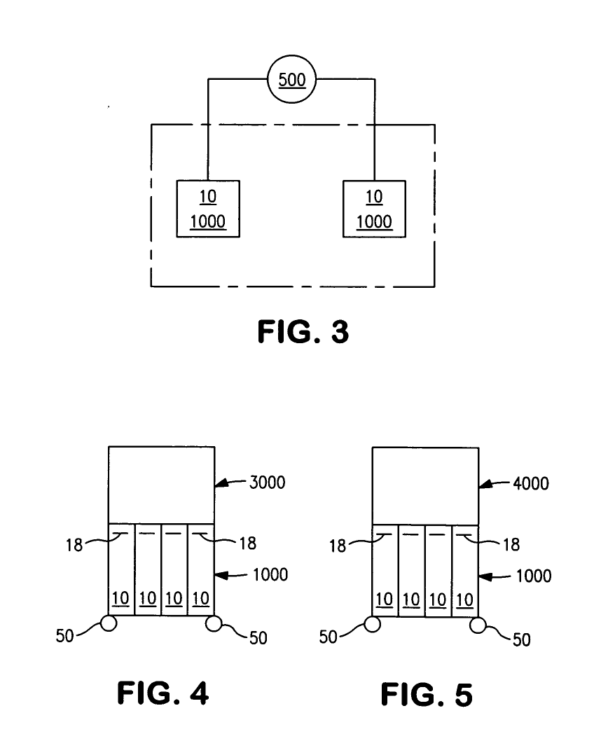

FIG. 3 is a schematic illustration of two valuable-item storage units that utilize a pendular system;

FIG. 4 illustrates schematically the valuable item storage unit docked to or connected to a cash unit;

FIG. 5 is a schematic illustration of the valuable item storage unit docked to or connected with an automatic telling machine (ATM-machine); and

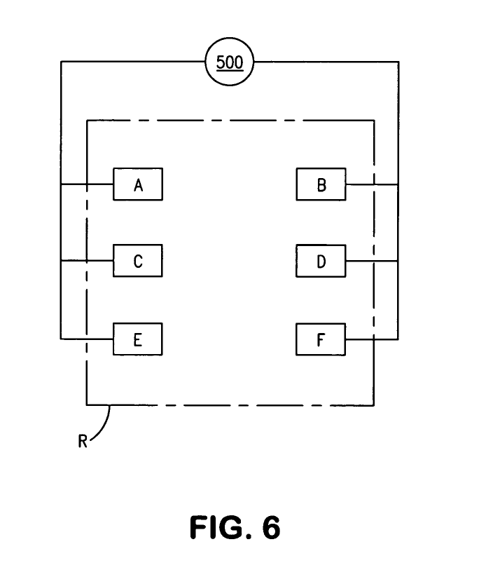

FIG. 6 is a schematic illustration of a group of valuable item storage units from which it can be seen that the pendular or alternating movement pattern of the units can be varied and controlled through the medium of a supervising security management centre or cash point.

FIGS. 1 and 2 illustrate a valuable item storage unit 10 that comprises a protective shell/protective casing 11 which communicates with an alarm device 12 which, in turn, communicates with a destructive device 13. Should any unauthorized person attempt to access the valuable contents of the unit 10, for instance its banknote content, by penetrating or manipulating the protective casing 11, the alarm device will activate the destructive device 13 such as to destroy, stain, the banknotes. The valuable item storage unit 10 is designed so that unauthorized attempts to manipulate the unit will result in staining and/or destruction of the contents of the unit, for instance banknotes stored therein.

The unit 10 includes means 15 for collecting and dispensing valuable items/banknotes. In the case of the illustrated embodiment, the collecting device/dispensing device 15 includes a rotatable drum 16 that is reversible, and a carrier film arrangement 17 which is adapted to enable, for instance, banknote to be fed-in and fed-out through a slot 18 in the exterior of the unit, wherein when banknotes are deposited the carrier films 20, 21 transfer banknotes between the slot 18 and the drum 16 such as to roll the banknotes onto the drum 16 together with a part of the carrier films. In the banknote dispensing mode of the arrangement, the carrier films 20, 21 function to transport banknotes from the drum 16 to the slots 18. The in feed and the out feed of banknotes is governed respectfully by the direction in which the drum 16 rotates and the direction in which the carrier films 20,21 are moving. The carrier films 20,21 are each stored on a respective reversible storage drum 22,23 and are guided by a number of deflection rollers/guide rollers, as will be evident from FIG. 2.

The valuable item storage unit 10 also includes an electronic device or processor 19 which registers the banknote content/valuable item content of the unit and steers/controls the relevant manoeuvring commands. The electronic unit/processor 19 can be coupled to, for instance, an electronic unit/processor of, for instance, a store cash-point or the like and/or to an electronic unit/processor of an automatic telling machine (ATM-machine) and/or, for instance, to a command centre, control centre, cash centre or the like. These connections may, for instance, be direct connections or connections achieved through the medium of radio communication or the like.

FIG. 3 illustrates two valuable item storage units 10 or a pack of valuable item storage units 1000 which communicate with a control centre/command centre/cash centre 500.

FIG. 4 illustrates a pack of valuable item storage units 1000 which includes four value units 10, one for a respective banknote denomination. In the illustrated embodiment, the units are in communication with an operating unit 3000 for a cash-point. The cash-point operator feeds received banknotes into relevant units 10, and any banknotes required by the customer by way of change is/are taken from respective units 10.

FIG. 5 illustrates a valuable item storage pack 1000 which comprises four value units 10, one for each relevant banknote denomination. This illustrated pack of units is in communication with an operating unit 4000 for an automatic dispensing machine or automatic telling machine (ATM-machine). The operating unit 4000 will, of course, include a card reader, a button bank, display etc.

According to the inventive method the valuable item storage units 10 or the valuable item storage pack 1000 concerned may be used at more than one user station, by, for instance, moving a unit 10 or a unit pack 1000 filled with banknotes from a shop cash-point to an automatic banknote dispensing machine or automatic telling machine. Conversely, a unit 10 or a unit pack 1000 which have been emptied of its banknotes can be moved to a shop cash-point and there be successively filled with banknotes for later transfer to the automatic dispenser/automatic telling machine, etc. Requisite communications and couplings will, of course, be established at each user station. Purposeful handshakes and acceptance procedures are suitably adapted to guarantee secure re-dockings to new user stations/user units, such as shop cash-points and automatic dispensing units for instance.

The inventive method thus enables alternate use of valuable item storage units 10 or packs of such units 1000 to be achieved within a desired region R in which varying flows of banknotes occur at different user stations A-F, so as to minimize the requirement of region-external transportation of banknotes. The units 10 thus constantly protect the banknotes and effectively minimize the number of naked, unprotected banknotes.

Registration of the amount of cash involved and the ownership of the cash, together with logistical decisions, is preferably undertaken by a cash centre/control centre/command centre 500 or the like security management centre. It is also possible to delegate at least some of these tasks to the valuable item storage unit 10.

It should be mentioned that a region R may, of course, vary in size within the scope of the inventive concept. This also applies, of course, to the number of user stations. For instance, appropriate regions may comprise a shopping complex, a departmental store, a precinct, a town and still larger geographical areas, within which the pendular or unit exchange concept of the inventive method can be applied to achieve continuous cash protection.

FIG. 6 illustrates a region R that includes six mutually different user stations A-F, wherein a valuable item central control station/central command station 500 controls the logistics, i.e. the alternating movement pattern/pendular movement pattern of valuable item storage units/packs of valuable-item storage units between different user stations.

The units or unit packs may be supported by wheels 50 to facilitate their transportation.

It will be understood that many variations in structural details are possible within the framework of the present inventive concept.

The structural design of the units 10 may be widely varied. For example, the banknote drum 16 and its peripheral arrangement described above may be replaced with an alternative banknote handling arrangement that is qualified to receive and dispense banknotes.

It will be understood that the user stations exemplified above—shop cash-points, automatic dispensing machines—shall not be understood as limiting the scope of the invention, as other user stations are, of course, possible within the scope of the invention. It will also be understood that varying pendular patterns or unit movement patterns can be used, and that the movement can be direct or indirect.

Thus, the described stations between which the valuable items are transferred, a shop cash-point and automatic telling machine do not limit the area of application of the invention, since many alternative interacting stations are, of course, possible within the framework of the inventive concept, such as mutually combined depositing and dispensing machines etc.

The invention is thus not restricted to the illustrated and described embodiments thereof, since changes and modifications can be made within the scope of the accompanying claims.

1. A method of handling valuable items, such as banknotes and the like, in which there is used a valuable item storage unit (10) which is adapted for receiving and dispensing valuable items/banknotes, wherein said unit (10) preferably includes an alarm device (12) and a destructive device/staining device/marking device (13), characterized by moving the unit (10) between at least two different user stations in which the ability of the unit to receive and/or to dispense valuable items/banknotes is utilized.

2. A method according to claim 1, characterized by controlling the movement pattern of the unit (10) from a command centre/supervising centre/valuable item management centre (500).

3. A method according to claim 1, characterized by adapting the unit (10) for communication with a cash-point unit (3000) located at a user station and a dispensing unit (4000) located at another user station, such as to enable pendular/alternate use of the unit (10).

4. A method according to claim 1, characterized by using at least two units (10) in a transfer pattern between different user stations (A-F).

5. A method according to claim 1, characterized in that at least two units (10) are adapted to form a valuable item storage pack (1000), wherein the pack is moved to at least two different user stations and there included in a unit or in a system for receiving and/or dispensing valuable items/banknotes.

6. A method according to claim 1, characterized in that user stations and/or valuable item storage units concerned have dialogue communication with a common supervising centre, cash centre, command centre (500) or the like security management centre for registering the ownership of said valuable items and for registration of other operational and mapping procedures, etc.

7. A use of a valuable item storage unit (10) or a pack (1000) of such units adapted for receiving and dispensing valuable items, such as banknotes for instance, wherein the valuable unit/unit pack (10/1000) preferably includes an alarm device (12) and a destructive device/staining device/marking device (13), characterized in that the unit (10) or the unit pack (1000) is used in a pendular fashion between at least two user stations in which respective units/unit packs (10/1000) communicate with an operating unit (3000;4000) for ordering the receipt of valuable items/banknotes and/or the dispensing of valuable items/banknotes.

8. A use according to claim 7, characterized in that the unit (10) or the unit pack (1000) is used alternately between at least two mutually different user stations, wherein the unit/the unit pack (10/1000) is used as a first user station as part of a shop cash-point (3000) or the like and in a second user station is used as a part of an automatic dispensing machine (4000) or the like.
